(19) United States
(12) Patent Application Publication
(10) Pub. No.: US 2012/0007860 A1
(43) Pub. Date: Jan. 12, 2012

(54) STEREOSCOPIC IMAGE DISPLAY APPARATUS AND OPTICAL SHUTTER ARRAY

(75) Inventor: Hiroyuki HIIRO, Kanagawa-ken (JP)

(73) Assignee: FUJIFILM CORPORATION, Tokyo (JP)

(21) Appl. No.: 13/179,330

(22) Filed: Jul. 8, 2011

(30) Foreign Application Priority Data
Jul. 8, 2010 (JP) 156022/2010

(51) Int. Cl. G06T 15/00; G02F 1/19

(52) U.S. Cl. 345/419; 359/260

(57) ABSTRACT

An optical shutter array is constituted by a first electrode that transmits three colors of light, a modulating layer that transmits the three colors of light transmitted through the first electrode, formed by a material of which the refractive index changes by application of voltage; and a second electrode constituted by a plurality of linear electrodes arranged in each of a plurality of divided regions, into which pixel portions have been divided, that transmit the three colors of light transmitted through the modulating layer. The first electrode, the modulating layer, and the second electrode are layered and provided between a pair of partially light transmitting mirrors. A configuration is adopted, in which the three colors of light transmitted through the linear electrodes are sequentially transmitted through the partially light transmitting mirror by sequentially switching and applying voltages to the linear electrodes.

### BACKGROUND OF THE INVENTION

1. Field of the Invention

The present invention is related to a stereoscopic image display apparatus that displays color stereoscopic images constituted by a plurality of color parallax images, which are respectively observed from different viewpoint directions, and an optical shutter array to be employed in the stereoscopic image display apparatus.

2. Description of the Related Art

Conventionally, various stereoscopic image display apparatuses have been proposed. Stereoscopic image display apparatuses are capable of displaying images that can be viewed stereoscopically (hereinafter, referred to as “stereoscopic images”) by combining and displaying a plurality of images of the same subject having parallax with respect to each other, obtained by performing photography from different directions.

As an example of a type of conventional stereoscopic image display apparatus, there are those provided with an electronic shutter array forward of an image display screen, as disclosed in Japanese Unexamined Patent Publication Nos. H4-107086, H6-78342, H4-250439, and H9-43540. In this type of stereoscopic image display apparatus, an image for the right eye and an image for the left eye are alternately switched by the shutter array, to display a stereoscopic image.

Specifically, the aforementioned patent documents disclose methods in which liquid crystals are employed as the electronic shutter array to control the polarization direction of incident light.

Shutter arrays that employ liquid crystals can be produced as comparatively low cost. However, the response speed is approximately 10 ms at best, and such shutter arrays do not exhibit high speed response properties. For this reason, shutter arrays that employ liquid crystals cannot perform high speed shutter driving. Shutter arrays that employ liquid crystals are limited to displaying two images for the left and right eyes, and it is extremely difficult to switch and display a number of parallax images corresponding to more than two viewpoints.

Note that when only parallax images corresponding to two viewpoints are displayed, a stereoscopic image can only be properly observed only in the case that the parallax images are viewed from a predetermined direction. A smoothly transitioning stereoscopic image cannot be observed in the case that an observer moves in a horizontal direction with respect to a stereoscopic image display apparatus, for example. Accordingly, it is desirable for stereoscopic image display apparatuses to switch and display a great number of parallax images corresponding to more than two viewpoints.

Electronic shutter arrays of the polarization control transmission type that employ solid state birefringent electrooptical materials, such as electrooptical ceramics, e.g., PLZT, and electrooptical crystals, instead of liquid crystals may also be considered.

These materials exhibit high speed response properties, but have small electrooptical coefficients. Therefore, it is necessary to either form a layer of electrooptical material to be thick or to apply high voltages, in order to obtain a desired amount of phase modulation.

However, the degree of technical difficulty in producing a large area solid state birefringent electrooptical film having a thick layer thickness and favorable optical and electrooptical properties. Further, a polarizing plate and a wavelength plate will be necessary in front of and behind the solid state birefringent electrooptical film in order to enable the film to function as a shutter. In addition, a drive power source that supplies high voltage will become necessary, resulting in extremely high costs.

Polarization control transmission type electronic shutter arrays have thick layer thicknesses as a whole. Therefore, it is extremely difficult to produce a shutter array having a fine pitch.

Meanwhile, Japanese Unexamined Patent Publication Nos. S63-194285, H1-102415, 2002-62493, 2005-77718, and 2007-272247 disclose color image display apparatuses that switch and display color images having different colors.

Japanese Unexamined Patent Publication Nos. S63-194285 and H1-102415 propose to cause a Fabry Perot variable interference apparatus to function as a variable color filter, by changing the optical path length between a pair of opposing reflecting mirrors, to display desired color images.

However, substantial optical path length changes (50% or greater) are necessary to cover a visible light range by changing the optical path length between a pair of opposing reflecting mirrors of a Fabry Perot variable interference apparatus. Effecting such optical path changes by refractive index changes of a solid state electrooptical material such as PLZT has been proposed, but it is difficult to realize this proposal.

Specifically, a method in which the space between reflecting mirrors is formed as an air layer, and the space is varied utilizing the electrostrictive effect and electrostatic attractive force has been proposed. However, it is difficult to stably hold and control the air layer interval to be uniform in methods that utilizes the electrostrictive effect and electrostatic attractive force. Therefore, the color control properties are poor.

In addition, because such a configuration is mechanically driven, it is difficult to achieve high speed response to cover the entire range of visible light. Further, it is necessary to produce complex shapes using fine processing techniques, and it is difficult to produce a variable interference apparatus in which fine shapes are arranged two dimensionally over a large area, resulting in high costs.

Japanese Unexamined Patent Publication No. 2002-62493 proposes a display element that employs an interference modulating element (IMOD) that deforms a movable reflecting film. Japanese Unexamined Patent Publication Nos. 2005-77718 and 2007-272247 disclose reflective display apparatuses provided with a transparent substrate, a thin optical film formed on the transparent substrate, and an absorber layer provided to face the thin optical film such that the distance between the absorber layer and the thin optical film is variable.

The Fabry Perot variable interference apparatuses proposed in Japanese Unexamined Patent Publication Nos. 2002-62493, 2005-77718, and 2007-272247 obtain desired interference modulation effects and display functions by mechanically moving one of a pair of mirrors which are arranged to face each other. Because these Fabry Perot variable interference apparatuses are mechanically driven, they exhibit the same problems as the Fabry Perot variable interference apparatuses of Japanese Unexamined Patent Publication Nos. S63-194285 and H1-102415.

### SUMMARY OF THE INVENTION

The present invention has been developed in view of the foregoing circumstances. It is an object of the present invention to provide a stereoscopic image display apparatus capable of displaying color parallax images corresponding to two or more viewpoints at a sufficiently high speed repetition frequency that enables stereoscopic images to be observed naturally having a simple structure and which can be produced at low cost.

A stereoscopic image display apparatus of the present invention comprises:

an image display section, in which a plurality of pixel portions equipped with light emitting sections that emit three colors R, G, and B are arranged two dimensionally, that displays two or more color parallax images that constitute at least one stereoscopic image in temporal series;

an optical shutter array provided at the front surface of the image display section that sequentially switches transmission of the three colors of light emitted by each of the pixel portions synchronized with the switched display of the color parallax images among a plurality of divided regions, into which a range corresponding to the pixel portions is divided;

a directionality adding element that causes the three colors of light which have passed through each divided region of the optical shutter array to be emitted in different viewpoint directions for each of the divided regions;

the optical shutter array being equipped with a pair of partially light transmitting mirrors, a first electrode that transmits the three colors of light, a modulating layer that transmits the three colors of light transmitted through the first electrode, formed by a material of which the refractive index changes by application of voltage, and a second electrode constituted by linear electrodes that transmit the three colors of light transmitted through the modulating layer and which are arranged for each of the divided regions, the first electrode, the modulating layer, and the second electrode being layered and provided between the pair of partially light transmitting mirrors; and

a drive section that sequentially switches and applies voltages to the linear electrodes such that the three colors of light emitted by the pixel portions of the image display section are sequentially switched and transmitted for each of the divided regions of the optical shutter array.

In the stereoscopic image display apparatus of the present invention may adopt a configuration wherein:

the optical shutter array is a Fabry Perot wavelength sweeping filter shutter array having a plurality of peak transmission wavelengths; and

the effective optical path length between the pair of partially light transmitting mirrors is set such that each of the peak transmission wavelengths and the peak intensity wavelengths of the light emitting spectra of the R colored light, the G colored light, and the B colored light emitted by the pixel portions are substantially matched, respectively.

The stereoscopic image display apparatus having the aforementioned optical shutter array may adopt a configuration wherein the effective optical path length L_{eff} between the pair of partially light transmitting mirrors is set to satisfy Formulas (1) and (2) below.

$${λ}_{m \pm l} = \frac{m {λ}_{m}}{m \pm l} \qquad ( 1 )$$

wherein:

λₘ: the peak intensity wavelength of the G colored light

λₘ₊ₗ: the peak intensity wavelength of the R colored light

λₘ₋ₗ: the peak intensity wavelength of the B colored light

m: a positive integer

l: a positive integer smaller than m

$${L}_{eff} = \frac{m {λ}_{m}}{2} \qquad ( 2 )$$

The changes in the refractive index of the modulating layer may be set such that the plurality of peak transmission wavelengths are shifted by voltage being applied to the linear electrodes corresponding to the divided regions, to switch between transmission and blocking of the R colored light, the G colored light, and the B colored light emitted by the pixel portions.

The spectral widths of the plurality of peak transmission wavelengths of the optical shutter array may be narrower than the amount of shifting of the peak transmission wavelengths.

The reflectance of each of the partially light transmitting mirrors that constitute the pair of partially light transmitting mirrors may be 80% or greater.

Each of the light emitting sections may be constituted by a light emitting element and filter portions that narrow the wavelength band of the light emitted by the light emitting element into R colored light, G colored light, and B colored light; and

the filter portion corresponding to the R colored light, the filter portion corresponding to the G colored light, and the filter portion corresponding to the B colored light may be arranged such that the arrangement direction thereof matches the direction in which the linear electrodes extend.

The bandwidths at half maximum δλ_{R,G,B} of the narrow band R colored light, the narrow band G colored light, and the narrow band B colored light may be those that satisfy Formula (3) below.

$${δλ}_{R , G , B} \leq \frac{2 δ {nL}_{C}}{m} \qquad ( 3 )$$

wherein:

δn: the refractive index modulation of the modulating layer

L_{C}: the distance between the pair of partially light transmitting mirrors

m: a positive integer

The modulating layer may be formed by a ceramic or a polymer.

The thickness of the optical shutter array may be 1.5 μm or less.

An optical shutter array of the present invention comprises:

a pair of partially light transmitting mirrors;

a first electrode that transmits R colored light, G colored light, and B colored light emitted by each of a plurality of two dimensionally arranged pixel portions;

a modulating layer that transmits the three colors of light transmitted through the first electrode, formed by a material of which the refractive index changes by application of voltage; and

a second electrode constituted by a plurality of linear electrodes that transmit the three colors of light transmitted through the modulating layer;

the first electrode, the modulating layer, and the second electrode being layered and provided between the pair of partially light transmitting mirrors; and

the optical shutter array being configured to transmit the three colors of light through each of a plurality of divided regions, into which a range corresponding to the pixel portions is divided, by sequentially switching and applying voltages to the linear electrodes.

The stereoscopic image display apparatus of the present invention employs the optical shutter array constituted by: a pair of partially light transmitting mirrors; a first electrode that transmits R colored light, G colored light, and B colored light emitted by each of a plurality of two dimensionally arranged pixel portions; a modulating layer that transmits the three colors of light transmitted through the first electrode, formed by a material of which the refractive index changes by application of voltage; and a second electrode constituted by a plurality of linear electrodes that transmit the three colors of light transmitted through the modulating layer; the first electrode, the modulating layer, and the second electrode being layered and provided between the pair of partially light transmitting mirrors; and the optical shutter array being configured to transmit the three colors of light through each of a plurality of divided regions, into which a range corresponding to the pixel portions is divided, by sequentially switching and applying voltages to the linear electrodes. The directionality adding element causes the three colors of light which have passed through each divided region of the optical shutter array to be emitted in different viewpoint directions for each of the divided regions. Thereby, the stereoscopic image display apparatus of the present invention is capable of displaying color parallax images corresponding to two or more viewpoints at a sufficiently high speed repetition frequency that enables stereoscopic images to be observed naturally, has a simple structure, and can be produced at low cost.

### BRIEF DESCRIPTION OF THE DRAWINGS

FIG. 1 is a diagram that schematically illustrates the structure of a stereoscopic image display apparatus according to an embodiment of the present invention.

FIG. 2 is a partial cross sectional view that illustrates an active matrix substrate and an optical shutter array substrate.

FIG. 3 is a plan view that illustrates the positional relationships among RGB color filter layers provided on pixel circuits and linear electrodes of a second electrode.

FIG. 4 is a diagram that illustrates an example of a switching array circuit.

FIG. 5 is a diagram that illustrates an example of a switch circuit.

FIG. 6 is a diagram that schematically illustrates the structure of a Fabry Perot resonator.

FIG. 7 is a diagram that illustrates an example of transmission properties of the Fabry Perot resonator.

FIG. 8 is a diagram that illustrates an example of a DBR mirror.

FIG. 9 is a graph that illustrates a wavelength shift of an optical shutter and bandwidths at half maximum of RGB light.

FIG. 10 is a timing chart for explaining the operation of the stereoscopic image display apparatus of the present invention.

FIG. 11 is a diagram for explaining changes in the transmission properties of an optical shutter array substrate.

FIG. 12 is a diagram that illustrates a stereoscopic image display apparatus according to another embodiment of the present invention.

### DESCRIPTION OF THE PREFERRED EMBODIMENTS

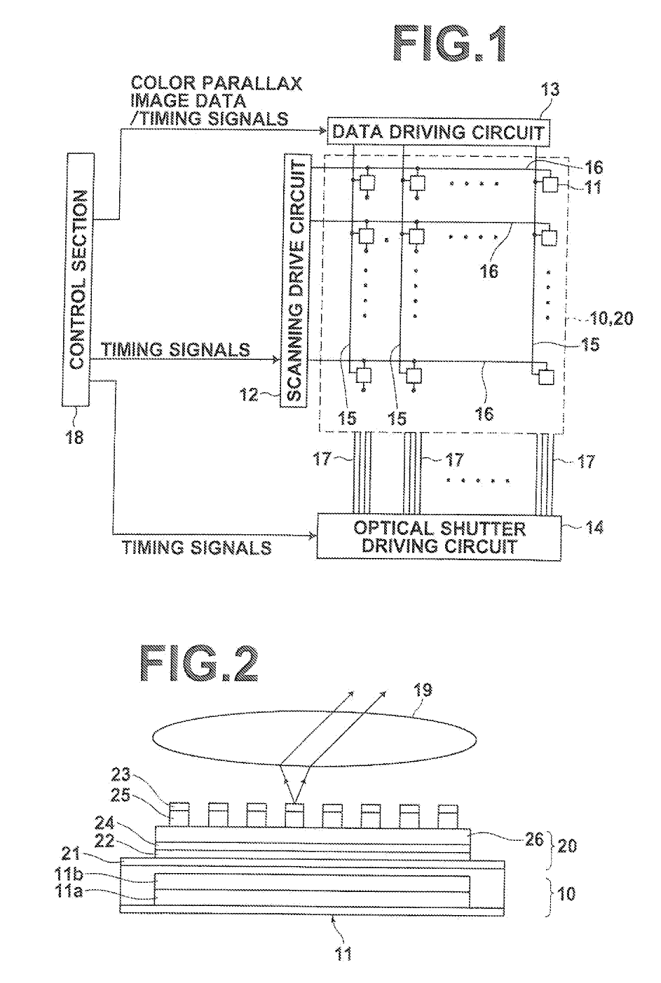

Hereinafter, an optical shutter array and a stereoscopic image display apparatus according to an embodiment of the present invention will be described with reference to the attached drawings. The characteristic feature of the stereoscopic image display apparatus of the present invention is the structure of the optical shutter array. First, the configuration of the stereoscopic image display apparatus as a whole will be described. FIG. 1 is a diagram that schematically illustrates the structure of the stereoscopic image display apparatus according to the present embodiment.

As illustrated in FIG. 1, the stereoscopic image display apparatus of the present embodiment is equipped with: an active matrix substrate 10, in which pixel circuits 11 having organic EL light emitting elements are arranged two dimensionally; an optical shutter array substrate 20 equipped with a great number of optical shutters, provided in front of the active matrix substrate 10; a scanning drive circuit 12; a data driving circuit 13; an optical shutter driving circuit 14, for sequentially switching and applying voltages to each of a plurality of linear electrodes to be described later, provided on the optical shutter array substrate 20; and a control section 18, for outputting color parallax image data and predetermined timing signals to the data driving circuit 13 and for outputting predetermined timing signals to the scanning drive circuit 12 and to the optical shutter driving circuit 14. Note that the optical shutter array substrate 20 is layered on the active matrix substrate 10, and therefore they are shown as a single rectangle in FIG. 1.

The active matrix is also equipped with: a great number of data lines 15, for supplying program voltages output from the data driving circuit 13 to each column of pixel circuits; and a great number of gate scanning lines 16, for supplying gate scan signals output from the scanning drive circuit 12 to each row of pixel circuits.

The optical shutter driving circuit 14 and the shutter array substrate 20 are connected via a great number of drive voltage lines 17 that supply optical shutter driving voltages output from the optical shutter driving circuit 14 to each linear electrode of the optical shutter array substrate 20. Each of the drive voltage lines 17 is respectively connected to each linear electrode of the optical shutter array substrate 20, and supply the optical shutter driving voltage to each linear electrode independently form one another.

Each pixel circuit 11 of the active matrix substrate 10 is equipped with: an organic EL light emitting element; a driving transistor, for causing a driving current corresponding to the program voltage supplied to the data line 15 to the organic EL light emitting element; and a gate selecting transistor, for switching a gate ON and OFF according to the gate scan signals supplied to the gate scanning line 16, provided between a gate terminal of the driving transistor and the data line 15.

The driving transistor and the gate selecting transistor are formed by TFT's (Thin Film Transistors) or MOS (Metal Oxide Semiconductor) transistors, for example.

The scanning drive circuit 12 sequentially outputs gate scan signals for turning the gate selecting transistors of the pixel circuits 11 ON and OFF to each gate scan line 16, based on timing signals output from the control section 18.

The data driving circuit 13 generates program voltages to be input to each pixel circuit 11 based on input color parallax image data, and outputs the program voltages to the data lines 15.

FIG. 2 is a partial cross sectional view that illustrates the active matrix substrate 10 and the optical shutter array substrate 20. Note that FIG. 2 is a cross sectional view that illustrates a single pixel circuit 11 of the active matrix substrate 10 and a portion of the optical shutter array substrate 20 that corresponds to the pixel circuit 11.

As illustrated in FIG. 2, the stereoscopic image display apparatus of the present embodiment is of a configuration in which the optical shutter array substrate 20 is layered on the active matrix substrate 10.

An organic EL light emitting elements 11a is provided in each pixel circuit 11 of the active matrix substrate 10. The organic EL light emitting element 11a is of a configuration in which a light emitting material formed by an organic compound is sandwiched between an anode and a cathode. This configuration is known, and therefore a detailed description thereof will be omitted. In addition, FIG. 2 only illustrates the organic EL light emitting element 11a of the pixel circuit 11. That is, structures such as the driving transistor and the gate selecting transistor are omitted from FIG. 2.

An RGB color filter layer 11b is provided on the front surface of the organic EL light emitting element 11a of each pixel circuit 11, as illustrated in FIG. 2. The color filter layer 11b is constituted by band pass filters for three colors R, G, and B. Light emitted by the organic EL light emitting element 11a enters the color filter layer 11b, and is output as R colored light, G colored light, or B colored light.

A multiple layered film color filter may be employed as the color filter layer 11b. However, it is desirable for the R colored light, the G colored light, and the B colored light to be output through the color filter layer lib to be narrow band light corresponding to the transmission properties of the optical shutter array substrate 20, to be described later. It is desirable for a Fabry Perot type band pass filter structure to be employed as a color filter array that realizes such narrow band light. The configuration of Fabry Perot type band pass filters is known, and therefore a detailed description thereof will be omitted.

As illustrated in FIG. 2, the optical shutter array substrate 20 is equipped with: a substrate 21 that transmits R colored light, G colored light, and B colored light emitted from the pixel circuits 11 of the active matrix substrate 10; and an optical shutter section layered on the substrate 21.

The optical shutter section is constituted by optical shutters of the Fabry Perot wavelength sweeping filter type. Specifically, the optical shutter section is equipped with pairs of partially light transmitting mirrors 22 and 23 as illustrated in FIG. 2. A first electrode 24 that transmits the R colored light, the G colored light, and the B colored light emitted by the pixel circuit 11; a modulating layer 26 that transmits the light transmitted through the first electrode 24, formed by a material of which the refractive index changes by application of voltage; and a second electrode 25 constituted by linear electrodes that transmit the three colors of light transmitted through the modulating layer 26; are layered between the pairs of partially light transmitting mirrors 22 and 23.

The pairs of partially light transmitting mirrors 22 and 23 constitute Fabry Perot resonators that exhibit transmissive properties selectively with respect to the narrow band R colored light, the narrow band G colored light, and the narrow band B colored light emitted by the pixel circuit 11 of the active matrix substrate 10.

The partially light transmitting mirror 22 toward the side of the active matrix substrate is formed as a flat plate. The partially light transmitting mirrors 23 toward the other side are formed as a plurality of linearly extending mirrors corresponding to the linear electrodes of the second electrode 25 to be described later. Note that the reflectances and transmissive properties of the partially light transmitting mirrors 22 and 23 will be described later.

The first electrode 24 and the second electrode 25 are formed by a material that transmits the narrow band R colored light, the narrow band G colored light, and the narrow band B colored light emitted by each of the pixel circuits 11, such as ITO. The first electrode 24 is formed as a flat plate, and the second electrode 25 is formed as a great number of linear electrodes. Note that the direction perpendicular to the drawing sheet of FIG. 2 is the direction in which the partially light transmitting mirrors 23 and the second electrode 25 extend.

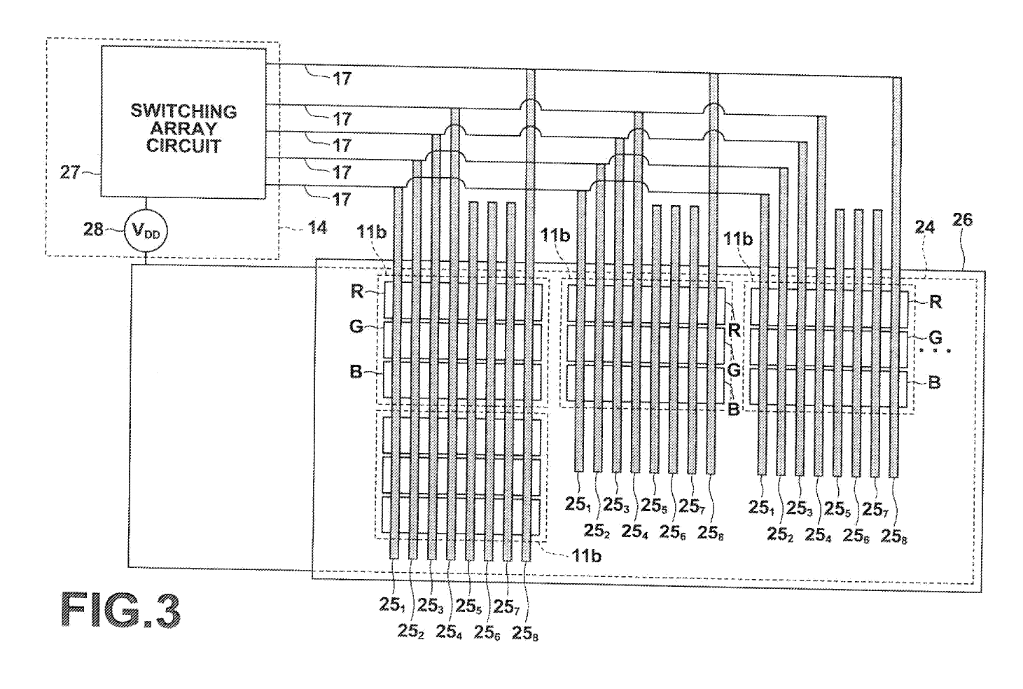

FIG. 3 is a plan view that illustrates the positional relationships among the linear second electrodes 25 of the optical shutter array substrate 20 and the RGB color filter layers 11b provided on the pixel circuits 11. FIG. 3 also illustrates the connective relationships among the second linear electrodes 25 of the optical shutter array substrate 20. In the present embodiment, eight linear electrodes 25₁ through 25₈ are provided as the second electrode 25 for the color filter layer 11b of each pixel circuit 11. The partially light transmitting mirrors 23 are provided corresponding to the linear electrodes. As illustrated in FIG. 3, the direction in which the linear electrodes 25₁ through 25₈ extend is set to be the same direction as the arrangement direction of the R, G, and B color filters of the color filter layers lib.

Each of the linear electrodes 25₁ through 25₈ provided corresponding to a single pixel circuit 11 are provided corresponding to predetermined parallax positions, respectively. As illustrated in FIG. 3, linear electrodes corresponding to each of the parallax positions are connected to each other at a region outside that of the pixel circuits 11. For example, a plurality of linear electrodes 25₁ corresponding to a first parallax position are connected to each other to form a first linear electrode group, and a plurality of linear electrodes 25₂ corresponding to a second parallax position are connected to each other to form a second linear electrode group. A third through eighth linear electrode groups are formed in a similar manner. The first through eighth linear electrode groups are layered via insulating films, such that the linear electrode groups are electrically insulated from each other.

The first through eighth linear electrode groups are respectively connected to the optical shutter driving circuit 14 via the drive voltage lines 17.

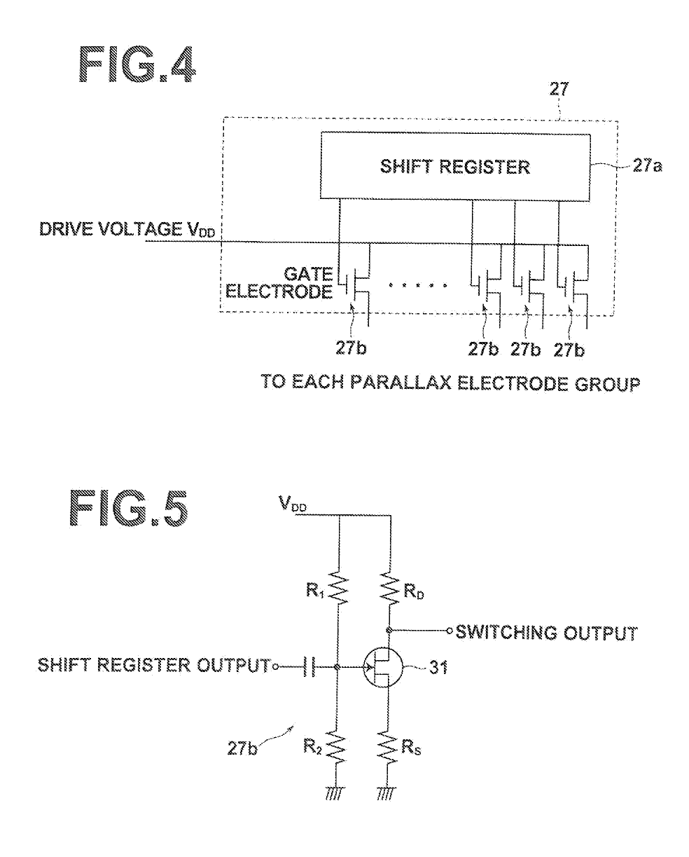

As illustrated in FIG. 3, the optical shutter driving circuit 14 is equipped with a switching array circuit 27 and a drive power source (V_{DD}) 28. As illustrated in FIG. 4, the switching array circuit 27 is equipped with: a shift register 27a; and a plurality of switching circuit sections 27b equipped with FET's (Field Effect Transistors).

The shift register 27a sequentially outputs gate voltage signals to the FET gate electrodes of each of the switching circuit sections 27b. The first through eighth linear electrode groups are respectively connected to each of the switching circuit sections 27b. The FET's of the switching circuit sections 27b are turned ON according to the gate voltage signals which are sequentially output from the shift register 27a, and optical shutter driving voltages are sequentially output to the first through eighth linear electrode groups in response to the ON operations of the FET's.

In greater detail, each of the switching circuit sections 27a is provided with an N channel coupling type FET 31 and four resistance elements R₁, R₂, R_{D}, and R_{S}. The drive power source (V_{DD}) 28 is connected to the drain terminal of the FET 31. The gate voltage signals which are output from the shift register 27a are supplied to the gate electrodes of the FET's 31, in response to which the optical shutter driving voltage for turning the optical shutter ON is output from an output terminal connected to the drain terminal of the FET's. Note that an optical shutter non driving voltage that turns the optical shutter OFF is output while the gate voltage signals are not being supplied to the gate electrodes of the FET's 31.

Note that the present embodiment employs the N channel coupling type FET's. However, the present invention is not limited to this configuration. The switching circuit sections may be constituted by P channel coupling type FET's. As further alternatives, the switching circuit sections may be constituted by Schottky type FET's, MOS type FET's, bipolar transistors, or the like.

The modulating layer 26 of the optical shutter array substrate 20 is formed by a transparent ceramic, such as PLZT (Lead Lathanium Zirconium Titanium), or an electrooptical material, such as an EO polymer. When voltages are applied to the linear electrodes 25₁ through 25₈ of the second electrode 25, the birefringence of the portions of the modulating layer 26 corresponding thereto change. The central transmission wavelength shifts due to the change in birefringence, thereby controlling output and non output of the R colored light, the G colored light, and the B colored light from the partially light transmitting mirror 23 corresponding to the linear electrodes, to realize the functions of an optical shutter. Note that the necessary refractive index of the modulating layer 26 will be described later.

Although omitted from FIG. 1, a directionality adding element 19 that causes the light emitted by the organic EL light emitting elements 11a of the pixel circuits 11 to be output in predetermined viewpoint directions is provided in front of the optical shutter array substrate 20, as illustrated in FIG. 2. A lenticular lens, a parallax barrier, or the like may be employed as the directionality adding element 19.

In the stereoscopic image display apparatus of the present embodiment, the R colored light, the G colored light, and the B colored light emitted by the organic EL light emitting elements 11a of the pixel circuits 11 are sequentially switched and emitted from regions corresponding to the linear electrodes 25₁ through 25₈ of the optical shutter array substrate 20. Color parallax images constituted by the R colored light, the G colored light, and the B colored light output from ranges corresponding to the linear electrodes are output in different viewpoint directions by the directionality adding element 19.

That is, in the present embodiment, eight linear electrodes are provided within a range corresponding to each of the pixel circuits 11. Therefore, color parallax images are output in eight viewpoint directions. From among these eight color parallax images, two color parallax images corresponding to an observation position with respect to the stereoscopic display apparatus enter the right eye and the left eye of an observer, respectively, to enable observation of a stereoscopic image. Because eight color parallax images are displayed as described above, appropriate stereoscopic images can be observed even if the position of the observer with respect to the stereoscopic image display apparatus shifts in the horizontal direction.

Note that eight color parallax images are displayed in the present embodiment. However, the present invention is not limited to this configuration, and a greater number of color parallax images may be displayed, by providing more than eight linear electrodes in the optical shutter sections corresponding to the pixel circuits 11. For example, 100 linear electrodes may be provided for each of the pixel circuits 11, to enable display of 100 color parallax images. In this case, appropriate stereoscopic images can be observed by observers at any position with respect to the stereoscopic image display apparatus.

Here, an embodiment of the optical shutter array substrate 20 constituted by the Fabry Perot wavelength sweeping filter type optical shutters will be described in detail.

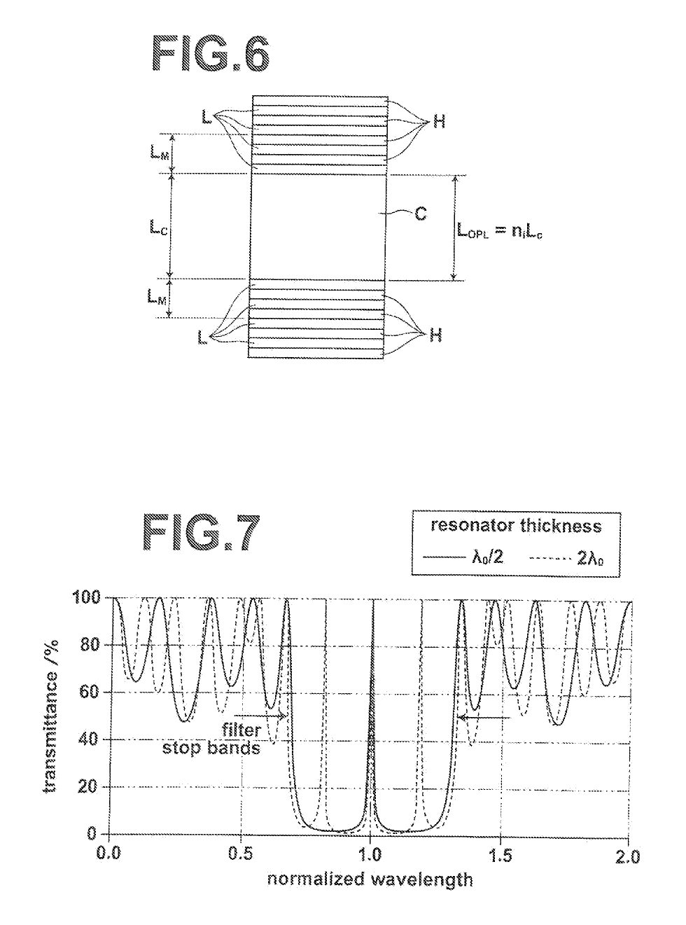

Generally, in the case that DBR mirrors (in which high refractive index layers H and low refractive index layers L having thicknesses of λ/4 are alternately layered) are employed as a pair of reflective mirrors as illustrated in FIG. 6, the light transmissive properties of a Fabry Perot resonator are those in which a plurality of transmissive peaks are present at filter stop bands of the reflective mirrors, as illustrated in FIG. 7. Note that the positions and widths of the plurality of transmissive peaks are determined by the free spectral range (FSR) and the finesse of the Fabry Perot resonator. FSR refers to the wavelength intervals among adjacent peaks, and are determined by the length L_{eff} of the Fabry Perot resonator. As L_{eff} becomes greater, the wavelength intervals among the transmissive peaks become narrower. Note that FIG. 7 illustrates an example of transmissive properties when L_{eff}=λ_{O}/2 and an example of transmissive properties when L_{eff}=2λ_{O}.

Here, the effective resonator length L_{eff} is the length L_{OPL}=niLc, to which penetration lengths L_{M} derived by phase shifts of waves reflected by the reflective mirrors are added. In the case that the same type of mirror is employed as both of the pair of reflective mirrors, L_{eff} can be calculated by Formula (1) below. Note that ni is the refractive index between the pair of reflective mirrors, and Lc is the distance between the pair of reflective mirrors.

L_{eff}=L_{OPL}+2L_{M} (1)

A specific formula that represents L_{M} in the case that DBR mirrors are employed is disclosed in “Theory of quarter wave stack dielectric mirrors used in a thin Fabry Perot filter”, APPLIED OPTICS Vol. 42, No. 27, pp. 5442-5449, 2003, for example. L_{M} can be uniquely determined by the formula.

At this time, the wavelength of the m^{th} order mode of the Fabry Perot resonator is determined by Formula (2) below.

$${L}_{eff} = \frac{m {λ}_{m}}{2} \qquad ( 2 )$$

In addition, the wavelength of a mode shifted l orders from the m^{th} order can be obtained by Formula (3) below.

$${λ}_{m \pm l} = \frac{m {λ}_{m}}{m \pm l} \qquad ( 3 )$$

The parameters of the Fabry Perot resonator may be determined as follows, in order to form a Fabry Perot resonator that simultaneously transmits light having a wavelength in the vicinity of 450 nm output from the B filter of the color filter 11b of the pixel circuit 11, light having a wavelength in the vicinity of 550 nm output from the G filter of the color filter 11b of the pixel circuit 11, and light having a wavelength in the vicinity of 650 nm output from the R filter of the color filter 11b of the pixel circuit 11.

First, a light beam λₘ having a wavelength in the vicinity 550 nm that satisfies the condition 500 nm≦λₘ≦600 nm is selected.

Next, m and l are selected such that λₘ₊ₗ of Formula (3) satisfies the conditions 400 nm≦λₘ₊ₗ≦500 nm and 600 nm≦λₘ₋ₗ≦700 nm. Then, L_{eff} is determined by Formula (2) using the selected values for λₘ and m.

In the present embodiment, the parameters were calculated with λₘ=530 nm. Further, as a result of calculations with l=1, λₘ₊ₗ=454 nm and λₘ₋ₗ=636 nm when m=6. In this case, L_{eff}=1.59 μm.

Here, when optical path length modulation of the Fabry Perot resonator occurs due to the refractive index modulation of the modulating layer 26, the wavelength of each ordinal mode shifts according to Formula (2). It is necessary to cause the resonator peak spectrum widths for each order of the Fabry Perot resonator to be narrower than the amount of wavelength shift, in order to utilize this wavelength shift to cause the Fabry Perot resonator to function as a shutter.

The amount of wavelength shift δλ for an m^{th} order mode of the Fabry Perot resonator by the refractive index modulation δn of the modulating layer 26 can be approximately represented by Formula (4) below

$$δλ = \frac{2 δ {nL}_{c}}{m} \qquad ( 4 )$$

The resonator peak spectrum width Δλ at the m^{th} order mode can be represented by Formula (5) below

$$Δλ = \frac{{λ}_{m}}{{m}^{2} F} \qquad ( 5 )$$

wherein F: the finesse of the Fabry Perot resonator

Based on the above, it is necessary to set the finesse of the Fabry Perot resonator to a sufficiently large value that satisfies Formula (6) below, in order to cause the resonator peak spectrum widths Δλ for each order of the Fabry Perot resonator to be narrower than the amount of wavelength shift δλ.

$$F \geq \frac{{λ}_{m}}{2 m δ {nL}_{c}} ≅ \frac{1}{{m}^{2} δ n} \qquad ( 6 )$$

Here, the finesse of the Fabry Perot resonator is represented by Formula (7) below, in the case that the pair of reflective mirrors are the same type of mirror, having a reflectance R.

$$F = \frac{π \sqrt{R}}{1 - R} \qquad ( 7 )$$

Based on the above, it is necessary for high reflectance mirrors to be employed as resonator mirrors, in order to satisfy Formula (6) above.

In the present embodiment, PLZT is employed as the modulating layer 26 within the Fabry Perot resonator. A case will be considered in which the refractive index n of PLZT is n≈2.5, and refractive index modulation of approximately 0.1% is performed. This is an amount of modulation which is possible with application of a comparatively low voltage. At this time, assuming that δn=2.5×0.001=0.0025, Formula (6) yields F≧11. Accordingly, the reflectance R of the DBR mirrors should be 80% or greater, according to Formula (7).

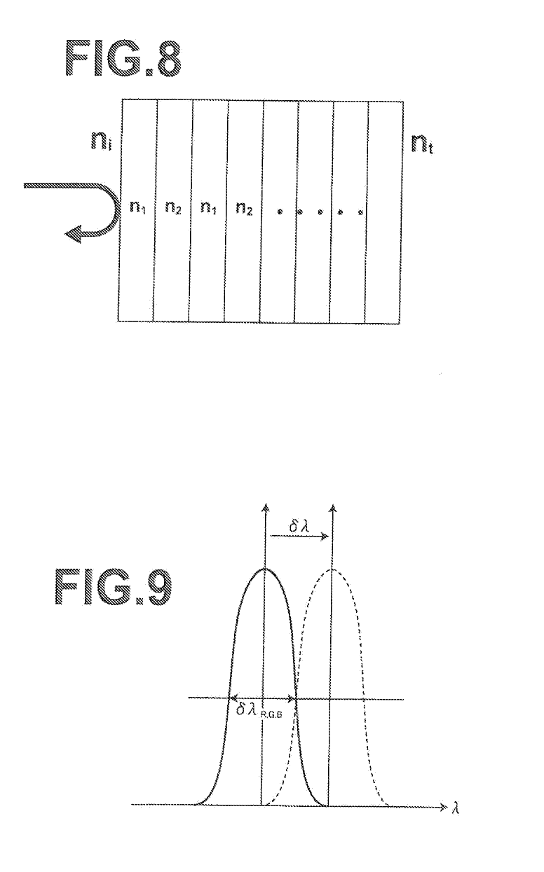

In the case that the reflective mirrors are constituted as DBR mirrors with respect to wavelength λₘ as illustrated in FIG. 8, the maximum mirror reflectance value is obtained by Formula (8) below, and is determined by the refractive index ratio between the high refractive index layers H and the low refractive index layers L. Here, p represents the number of pairs of alternately layered refractive index layer pairs.

$${R}_{max} = {( \frac{1 - ( {n}_{t} / {n}_{i} ) {( {n}_{1} / {n}_{2} )}^{2 p}}{1 + ( {n}_{t} / {n}_{i} ) {( {n}_{1} / {n}_{2} )}^{2 p}} )}^{2} \qquad ( 8 )$$

In the present embodiment, the DBR mirrors are high reflectance mirrors having reflectance of 80% or greater. Therefore, when a case in which nᵢ=2.5 (PLZT) and nₜ=1.5 is considered, the ratio of the refractive index n₁ of the low refractive index layers L and the refractive index n₂ of the high refractive index layers H may be n₂/n₁≧1.27. For example, in the case that n₁=1.5, n₂ needs to satisfy n₂≧1.9. Note that here, p=5.

In addition, the standardized stop band width of the DBR mirrors is obtained by Formula (9) below.

$$\frac{{Δλ}_{S}}{λ} = \frac{4}{π} a sin \vert \frac{{n}_{1} - {n}_{2}}{{n}_{1} + {n}_{2}} \vert \qquad ( 9 )$$

It is necessary for the stop band width to sufficiently cover the light emitting spectrum of the B colored light, which is set in the vicinity of 450 nm, and the light emitting spectrum of the R colored light, which is set in the vicinity of 650 nm, taking the line width thereof into consideration.

In the present embodiment, it is necessary for n₂ to satisfy the condition n₂≧2.54 in the case that n₁=1.47, in order to cover a wavelength range from 454 nm to 636 nm. This condition is more stringent than that derived from the condition regarding the finesse. Therefore, the present embodiment sets the refractive indices of the DBR mirrors to satisfy this condition.

The structure of the reflective mirrors can be determined from the above conditions. Further, the penetration lengths L_{M} of the reflective mirrors can also be determined. In the case that the reflective mirrors are DBR mirrors, the penetration length L_{M} can be derived by Formula (19) below.

$${L}_{M} = \frac{{n}_{1} {n}_{2} [ 1 - ( {n}_{t}^{2} / {n}_{1} {n}_{2} ) {( {n}_{1} / {n}_{2} )}^{2 p} ] [ 1 - {( {n}_{1} / {n}_{2} )}^{2 p} ]}{{n}_{i} ( {n}_{2} - {n}_{1} ) [ 1 - {( {n}_{t} / {n}_{i} )}^{2} {( {n}_{1} / {n}_{2} )}^{4 p} ]} ( \frac{{λ}_{m}}{4} ) \qquad ( 10 )$$

As an embodiment of the present invention, nᵢ was set to 2.5 (PLZT), and nₜ was set to 1.47. Then, films having n₁=1.47 (SiO₂) and n₂=2.6 (TiO₂) were formed by sputtering. At this time, the penetration length L_{M} of the DBR mirrors was 178.3 nm according to Formula (10) above. Further, the resonator length L_{OPL} was 1233.3 nm according to Formula (1) above.

Note that in the above calculations, the resonator length L_{OPL} includes the thicknesses of the first electrode 24 and the second electrode 25, which are formed as films above and below the resonator. Assuming that the refractive indices of the first electrode 24 and the second electrode 25 are 2.1 (ITO), and the thicknesses thereof are 100 nm respectively, the thickness of the modulating layer 26 (PLZT) will be 325.3 nm. Desired amounts of resonating peak wavelength shifts are capable of being adjusted by controlling the optical shutter driving voltage to be applied to the modulating layer 26.

Note that a Fabry Perot type band pass filter structure may be adopted as the color filter layer lib of each of the pixel circuits 11 of the active matrix substrate 10. In this case as well, the color filter layer lib may be designed in a manner similar to the Fabry Perot resonator described above. The Fabry Perot resonator is that in which the wavelengths of the R colored light, the G colored light, and the B colored light match peak transmission wavelengths.

Note that it is desirable for the bandwidths of the narrow band R colored light, the narrow band G colored light, and the narrow band B colored light to be sufficiently more narrow than the amount of wavelength shift δλ of the m^{th} order mode of the Fabry Perot resonator, in order for the optical shutter array substrate 20 constituted by the optical shutters of the Fabry Perot wavelength sweeping filter type to function as an optical shutter having a sufficient performance level. The amount of wavelength shift OX is represented by Formula (4) above.

Accordingly, the bandwidths at half maximum δλ_{R,G,B} of the narrow band R colored light, the narrow band G colored light, and the narrow band B colored light are set such that they satisfy Formula (11) below. Note that FIG. 9 is a graph that schematically illustrates the amount of wavelength shift δλ and the bandwidths at half maximum δλ_{R,G,B}.

$${δλ}_{R , G , B} \leq \frac{2 δ {nL}_{c}}{m} \qquad ( 11 )$$

Note that it is desirable for the bandwidths at half maximum δλ_{R,G,B} of the narrow band R colored light, the narrow band G colored light, and the narrow band B colored light to be set such that they satisfy the above formula not only in cases that the Fabry Perot type band pass filter structure is adopted as the color filter layer 11b, but also for cases in which an RGB multiple layer film is employed as the color filter layer 11b.

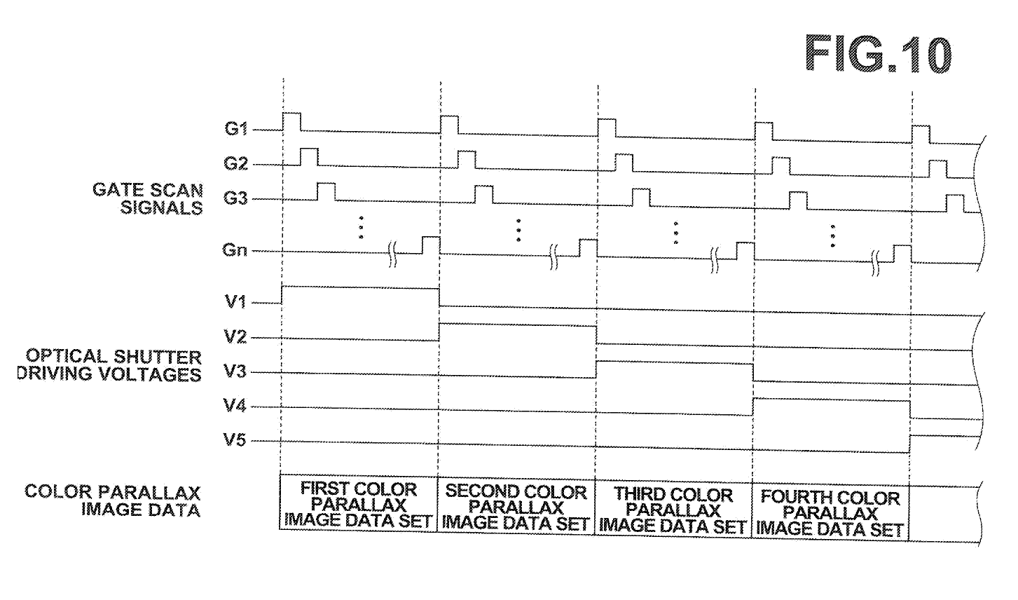

Next, the operation of the stereoscopic image display apparatus of the present invention will be described. FIG. 10 is a timing chart that illustrates gate scan signals which are output from the scanning drive circuit 12, optical shutter driving voltages which are output from the optical shutter driving circuit 14, and color parallax image data input to the data driving circuit 13.

The stereoscopic image display apparatus of the present embodiment sequentially switches and displays color parallax images for eight viewpoint directions within a single frame ( 1/60 sec, for example) by operation of the optical shutter array substrate 20.

Specifically, first, a first color parallax image data set for a first viewpoint direction is input to the data driving circuit 13. The data driving circuit 13 outputs program voltages corresponding to the first color parallax image data set to the data lines 15. At the same time, the optical shutter driving circuit 14 applies an optical shutter driving voltage V1 only to the first linear electrode group constituted by the first linear electrodes 25₁ of the optical shutter array substrate 20 via the drive voltage lines 17. Further, the scanning drive circuit 12 outputs a gate scan signal G1 that turns the gate selecting transistor ON to the first gate scanning lines 16. Note that an optical shutter non driving voltage is output to the second through eighth linear electrode groups of the optical shutter array substrate 20 at this time.

The gate selecting transistors of the pixel circuits 11 of the first row are turned ON by the gate scan signal G1 being output to the first gate scanning lines 16. Program voltage corresponding to the first row of the first color parallax image data set is applied to the driving transistors of the pixel circuits 11 of the first row. Driving current corresponding to the program voltage is caused to flow through the organic EL light emitting elements 11a of the pixel circuits 11 of the first row, the organic EL light emitting elements 11a emit light, and R colored light, G colored light, and B colored light are output from the pixel circuits 11 via the color filter layers 11b.

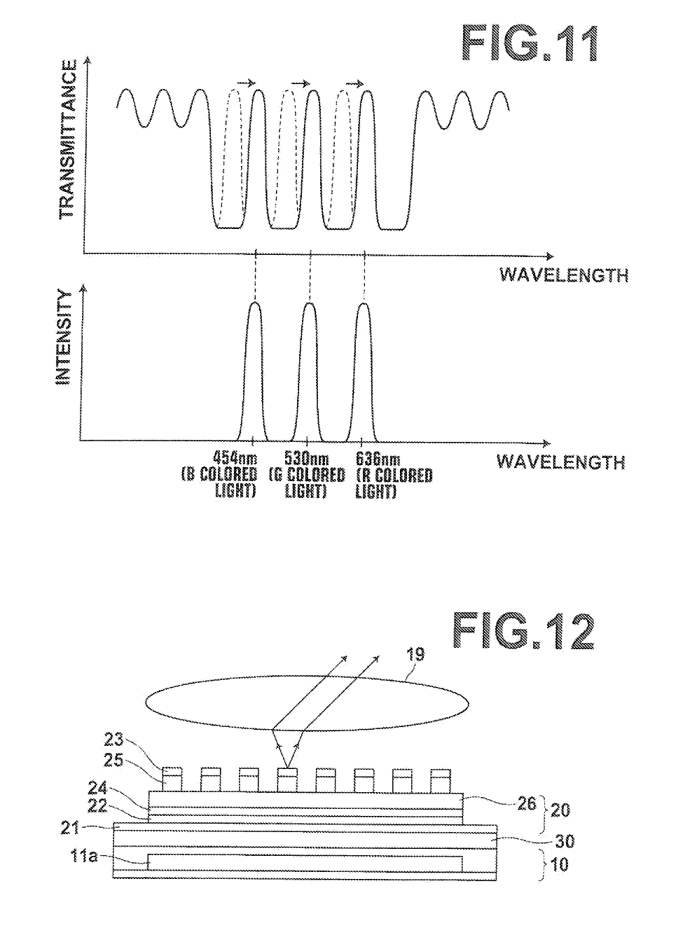

At this time, the refractive indices of the modulating layers 26 corresponding to the first linear electrode group change due to the application of the optical shutter driving voltage V1 to the first linear electrode group of the optical shutter array substrate 20. Thereby, the light transmissive properties of the range corresponding to the first linear electrode group change as illustrated in FIG. 11. That is, the central wavelengths of light which is transmitted shift in the direction indicated by the arrow, to substantially match the central wavelengths of the R colored light, the G colored light, and the B colored light emitted by the pixel circuits 11. Note that it is desirable for the bandwidths of the R colored light, the G colored, light, and the B colored light that passes through the color filter layers 11b of the pixel circuits 11 to substantially match the resonating peak spectrum widths of the optical shutter array substrate 20.

Only R colored light, G colored light, and B colored light emitted by a range of the pixel circuits 11 corresponding to the first linear electrode group of the optical shutter array substrate 20 are output, by the operation described above. Note that with respect to the ranges corresponding to the second through eighth linear electrode groups of the optical shutter array substrate 20, the central transmission wavelengths and the central wavelengths of the R colored light, the G colored light, and the B colored light of the pixel circuits 11 are not matched, and therefore, the R colored light, the G colored light, and the B colored light are not output.

As illustrated in FIG. 10, gate scan signals G2 through Gn for turning the gate selecting transistors for each row of the pixel circuits ON are switched and output from the scanning drive circuit 12 while the optical shutter driving voltage V1 is being applied to the first linear electrode group. Thereby, the gate selecting transistors of the pixel circuits for the second through n^{th} row are sequentially turned ON. At the same time, program voltages corresponding to each row of the first color parallax image data set are applied to the driving transistors of the pixel circuits 11 for the second through n^{th} row, and R colored light, G colored light, and B colored light are sequentially output from the pixel circuits for the second through n^{th} row. A single first color parallax image corresponding to the range of the first linear electrode group of the optical shutter array substrate 20 is output from the optical shutter array substrate 20 in this manner.

The first color parallax image output from the optical shutter array substrate 20 enters the directionality adding element 19, directionality is added by the directionality adding element 19, and the first color parallax image is output towards the first viewpoint direction.

Next, a second color parallax image data set for a second viewpoint direction is input to the data driving circuit 13. The data driving circuit 13 outputs program voltages corresponding to the second color parallax image data set to the data lines 15. At the same time, the optical shutter driving circuit 14 applies an optical shutter driving voltage V2 only to the second linear electrode group constituted by the second linear electrodes 25₂ of the optical shutter array substrate 20 via the drive voltage lines 17. Further, the scanning drive circuit 12 outputs a gate scan signal G2 that turns the gate selecting transistor ON to the second gate scanning lines 16.

The gate selecting transistors of the pixel circuits 11 of the first row are turned ON by the gate scan signal G1 being output to the first gate scanning lines 16. Program voltage corresponding to the first row of the second color parallax image data set is applied to the driving transistors of the pixel circuits 11 of the first row. Driving current corresponding to the program voltage is caused to flow through the organic EL light emitting elements 11a of the pixel circuits 11 of the first row, the organic EL light emitting elements 11a emit light, and R colored light, G colored light, and B colored light are output from the pixel circuits 11 via the color filter layers 11b.

At this time, the refractive indices of the modulating layers 26 corresponding to the second linear electrode group change due to the application of the optical shutter driving voltage V2 to the second linear electrode group of the optical shutter array substrate 20. Thereby, the light transmissive properties of the range corresponding to the second linear electrode group change as illustrated in FIG. 11.

Only R colored light, G colored light, and B colored light emitted by a range of the pixel circuits 11 corresponding to the second linear electrode group of the optical shutter array substrate 20 are output, by the operation described above. Note that with respect to the ranges corresponding to the first and third through eighth linear electrode groups of the optical shutter array substrate 20, the central transmission wavelengths and the central wavelengths of the R colored light, the G colored light, and the B colored light of the pixel circuits 11 are not matched, and therefore, the R colored light, the G colored light, and the B colored light are not output.

As illustrated in FIG. 10, gate scan signals G2 through Gn for turning the gate selecting transistors for each row of the pixel circuits ON are switched and output from the scanning drive circuit 12 while the optical shutter driving voltage V2 is being applied to the first linear electrode group. Thereby, the gate selecting transistors of the pixel circuits for the second through n^{th} row are sequentially turned ON. At the same time, program voltages corresponding to each row of the second color parallax image data set are applied to the driving transistors of the pixel circuits 11 for the second through n^{th} row, and R colored light, G colored light, and B colored light are sequentially output from the pixel circuits for the second through n^{th} row. A single second color parallax image corresponding to the range of the first linear electrode group of the optical shutter array substrate 20 is output from the optical shutter array substrate 20 in this manner.

The second color parallax image output from the optical shutter array substrate 20 enters the directionality adding element 19, directionality is added by the directionality adding element 19, and the second color parallax image is output towards the second viewpoint direction.

The color parallax image data sets, the gate scan signals, and the optical shutter driving voltages are sequentially switched as illustrated in FIG. 10 in the same manner as those during the operations to display the first color parallax image and the second color parallax image, to output third through eighth color parallax images, to which directionalities have been added by the directionality adding element 19, in third through eight viewpoint directions.

The stereoscopic image display apparatus of the present embodiment sequentially switches and displays color parallax images for eight viewpoint directions during a single frame ( 1/60 sec, for example) in the manner described above.

In the stereoscopic image display apparatus of the above embodiment, a color filter layer 11b was provided for each of the organic EL light emitting elements 11a of each of the pixel circuits 11. However, the present invention is not limited to such a configuration. For example, a color filter layer 30 may be provided separately from the active matrix substrate 10, and the active matrix substrate 10, the color filter layer 30, and the optical shutter array substrate 20 may be layered in this order, as illustrated in FIG. 12. The detailed structure of the color filter layer 30 is the same as that of the color filter layer 11b of the above embodiment. By adopting this configuration, a stereoscopic image display apparatus having functions equivalent to that of the above embodiment can be produced simply by adhesively attaching the color filter layer 30 and the optical shutter array substrate 20 to a general purpose active matrix substrate 10.

The stereoscopic image display apparatus of the above embodiment is of a simple structure and can be produced at low cost. At the same time, the stereoscopic image display apparatus is capable of displaying color parallax images corresponding to two or more viewpoints at a sufficiently high speed repetition frequency that enables stereoscopic images to be observed naturally.

In addition, the Fabry Perot wavelength sweeping filter type shutter array has no mechanically moving parts, and can be formed as a simple layered structure. Further, the solid state electrooptical medium that functions as the modulating layer can be formed thin. Therefore, miniaturization is possible compared to Fabry Perot variable interference apparatuses having mechanically moving parts, such as MEMS. Accordingly, a shutter array capable of handling a great number of color parallax images with respect to fine pixel circuits can be produced.

Further, high speed modulation is possible, and thin film solid state electrooptical media (transparent ceramics such as PLZT, EO polymers, etc.) may be employed as the modulating layer. Therefore, display can be driven at higher speed repetition frequencies compared to optical shutter arrays that include mechanically moving parts, such as liquid crystals and MEMS.

Still further, the optical shutter array is a Fabry Perot wavelength sweeping filter type shutter array. Thereby, the shutter array can be formed as a single layered structural member. Polarizing elements and wavelength plates can be omitted compared to shutter arrays that function by controlling the polarization of light, and the solid state electrooptical medium which is used as the modulating layer can be formed as a thin film. Therefore, costs can be greatly reduced.

What is claimed is:

1. A stereoscopic image display apparatus, comprising:
an image display section, in which a plurality of pixel portions equipped with light emitting sections that emit three colors R, G, and B are arranged two dimensionally, that displays two or more color parallax images that constitute at least one stereoscopic image in temporal series;
an optical shutter array provided at the front surface of the image display section that sequentially switches transmission of the three colors of light emitted by each of the pixel portions synchronized with the switched display of the color parallax images among a plurality of divided regions, into which a range corresponding to the pixel portions is divided;
a directionality adding element that causes the three colors of light which have passed through each divided region of the optical shutter array to be emitted in different viewpoint directions for each of the divided regions;
the optical shutter array being equipped with a pair of partially light transmitting mirrors, a first electrode that transmits the three colors of light, a modulating layer that transmits the three colors of light transmitted through the first electrode, formed by a material of which the refractive index changes by application of voltage, and a second electrode constituted by linear electrodes that transmit the three colors of light transmitted through the modulating layer and which are arranged for each of the divided regions, the first electrode, the modulating layer, and the second electrode being layered and provided between the pair of partially light transmitting mirrors; and
a drive section that sequentially switches and applies voltages to the linear electrodes such that the three colors of light emitted by the pixel portions of the image display section are sequentially switched and transmitted for each of the divided regions of the optical shutter array.

2. A stereoscopic image display apparatus as defined in claim 1, wherein:
the optical shutter array is a Fabry Perot wavelength sweeping filter shutter array having a plurality of peak transmission wavelengths; and
the effective optical path length between the pair of partially light transmitting mirrors is set such that each of the peak transmission wavelengths and the peak intensity wavelengths of the light emitting spectra of the R colored light, the G colored light, and the B colored light emitted by the pixel portions are substantially matched, respectively.

3. A stereoscopic image display apparatus as defined in claim 2, wherein the effective optical path length L_{eff} between the pair of partially light transmitting mirrors is set to satisfy Formulas (1) and (2) below.
$${λ}_{m \pm l} = \frac{m {λ}_{m}}{m \pm l} \qquad ( 1 )$$
wherein:
λₘ: the peak intensity wavelength of the G colored light
λₘ₊ₗ: the peak intensity wavelength of the R colored light
λₘ₋ₗ: the peak intensity wavelength of the B colored light
m: a positive integer
l: a positive integer smaller than m
$${L}_{eff} = \frac{m {λ}_{m}}{2} \qquad ( 2 )$$

4. A stereoscopic image display apparatus as defined in claim 2, wherein:
the changes in the refractive index of the modulating layer are set such that the plurality of peak transmission wavelengths are shifted by voltage being applied to the linear electrodes corresponding to the divided regions, to switch between transmission and blocking of the R colored light, the G colored light, and the B colored light emitted by the pixel portions.

5. A stereoscopic image display apparatus as defined in claim 3, wherein:
the changes in the refractive index of the modulating layer are set such that the plurality of peak transmission wavelengths are shifted by voltage being applied to the linear electrodes corresponding to the divided regions, to switch between transmission and blocking of the R colored light, the G colored light, and the B colored light emitted by the pixel portions.

6. A stereoscopic image display apparatus as defined in claim 4, wherein:
the spectral widths of the plurality of peak transmission wavelengths of the optical shutter array are narrower than the amount of shifting of the peak transmission wavelengths.

7. A stereoscopic image display apparatus as defined in claim 5, wherein:
the spectral widths of the plurality of peak transmission wavelengths of the optical shutter array are narrower than the amount of shifting of the peak transmission wavelengths.

8. A stereoscopic image display apparatus as defined in claim 1, wherein:
the reflectance of each of the partially light transmitting mirrors that constitute the pair of partially light transmitting mirrors is 80% of greater.

9. A stereoscopic image display apparatus as defined in claim 1, wherein:
each of the light emitting sections is constituted by a light emitting element and filter portions that narrow the wavelength band of the light emitted by the light emitting element into R colored light, G colored light, and B colored light; and
the filter portion corresponding to the R colored light, the filter portion corresponding to the G colored light, and the filter portion corresponding to the B colored light are arranged such that the arrangement direction thereof matches the direction in which the linear electrodes extend.

10. A stereoscopic image display apparatus as defined in claim 9, wherein:
the filter portions administer wavelength conversion onto the light emitted by the light emitting element to convert the light into the narrow band R colored light, the narrow band G colored light, and the narrow band B colored light.

11. A stereoscopic image display apparatus as defined in claim 10, wherein:
the bandwidths at half maximum δλ_{R,G,B} of the narrow band R colored light, the narrow band G colored light, and the narrow band B colored light satisfy Formula (3) below.
$${δλ}_{R , G , B} \leq \frac{2 δ {nL}_{C}}{m} \qquad ( 3 )$$
wherein:
δn: the refractive index modulation of the modulating layer
L_{C}: the distance between the pair of partially light transmitting mirrors
m: a positive integer

12. A stereoscopic image display apparatus as defined in claim 1, wherein:
the modulating layer is formed by one of a ceramic and a polymer.

13. A stereoscopic image display apparatus as defined in claim 1, wherein:
the thickness of the optical shutter array is 1.5 μm or less.

14. An optical shutter array, comprising:
a pair of partially light transmitting mirrors;
a first electrode that transmits R colored light, G colored light, and B colored light emitted by each of a plurality of two dimensionally arranged pixel portions;
a modulating layer that transmits the three colors of light transmitted through the first electrode, formed by a material of which the refractive index changes by application of voltage; and
a second electrode constituted by a plurality of linear electrodes that transmit the three colors of light transmitted through the modulating layer;
the first electrode, the modulating layer, and the second electrode being layered and provided between the pair of partially light transmitting mirrors; and
the optical shutter array being configured to transmit the three colors of light through each of a plurality of divided regions, into which a range corresponding to the pixel portions are divided, by sequentially switching and applying voltages to the linear electrodes.
